(19) United States
(12) Patent Application Publication
(10) Pub. No.: US 2018/0370028 A1
(43) Pub. Date: Dec. 27, 2018

(54) Autonomous Robotic Aide

(71) Applicant: Elizabeth Marie De Zulueta, Miami, FL (US)

(72) Inventor: Elizabeth Marie De Zulueta, Miami, FL (US)

(21) Appl. No.: 15/632,327

(22) Filed: Jun. 24, 2017

(51) Int. Cl. B25J 9/16; G05D 1/02; G10L 15/02; G06F 3/048

(52) U.S. Cl. CPC B25J 9/162; G05D 1/0274; G06F 3/048; G10L 15/02; G05D 1/0238

(57) ABSTRACT

An autonomous robotic aide and methods of its operation are provided herein. The robotic aide can carry and lift objects around the user's environment. The robot has a lifting mechanism which lifts the objects that are placed on the robot. It can assist users with picking up objects from the ground. The use of accessories may be combined with the robot's carrying and lifting functions to further assist the user. The robot can also map the user's environment for autonomous navigation. The robot can be given voice commands and can be controlled manually by integrating with a smart device.

### CROSS REFERENCE TO RELATED APPLICATIONS

This application claims the benefit of U.S. Provisional Patent Application No. 62/354,783 filed on Jun. 26, 2016, the contents of which are incorporated herein by reference.

### FIELD OF THE INVENTION OR TECHNICAL FIELD

This invention relates generally to the field of robotics and more specifically to a mobile robotic platform that can provide assistive services such as carrying, collecting and lifting household objects. These objects include, but are not limited to, common household items such as laundry baskets and grocery bags.

### BACKGROUND OF THE INVENTION

Robotics has been used in the manufacturing industry for decades, but the use of robotics in the household has been limited to task robots that perform cleaning functions such as pool cleaners and robotic vacuum cleaners. The field of assistive robotics is a new field.

One large problem that is ideal for the field of assistive robots to address is the growing number of individuals with difficulties carrying and lifting items. According to the U.S. Census Bureau, about 56.7 million people or about 19% of the population had a disability in 2010. Of which, 19.9 million people had difficulty lifting and grasping objects. Additionally, the older portion of the population also has a higher percentage of disabled individuals or individuals with reduced mobility. In the United States, there are 78 million Baby Boomers all of which are retired or near retirement. Not only is the population aging, but there is a growing number of individuals suffering from injuries which reduce their mobility. The U.S. Bureau of Labor Statistics cites back injuries as the leading cause of workman's compensation in the United States. Back injuries are one of the injuries which most leads to reduced mobility or restriction of carrying and lifting task. This robot will allow individuals with permanent or temporary mobility issues the ability to complete more tasks independently, thereby giving this population greater self-reliance and independence.

### BRIEF DESCRIPTION OF THE DRAWINGS

FIG. 1 Angled view of default position

FIG. 2 Side view of default position

FIG. 3 Angled view with the lift mechanism engaged

FIG. 3A Focused view of a latching mechanism

FIG. 4 Side view in a household setting

FIG. 5 Angled view of gripper accessory

FIG. 6 Bottom view of the robotic aide

FIG. 7 Process block diagram of the robotic aide's movement

FIG. 8 Finite state diagram that models the event driven software system

FIG. 9 Screen of the smart device application with control buttons for the drive motors

FIG. 10 Screen of the smart device with control buttons for the lift mechanism and tilt sensor interface for control of the drive motors

### DETAILED DESCRIPTION AND BEST MODE OF IMPLEMENTATION

An autonomous robotic aide is a mobile robot that performs tasks that assist humans. In this case, tasks include carrying and lifting household items. The robotic aide is designed to handle payloads up to 50 lbs or 23 kg. The robot is designed to lift its collection plate up to a prescribed height. These are usually associated with building codes, but are not limited to heights only predefined in the building code and may include programmable custom heights. This would allow the user to have increased customization and assistance specific to their needs. Since the robotic aide has the ability to function autonomously, a human is not required to manually control the robot at all times. Although, a manual control option is provided to the user. In the case of manual control, the robot may be connected to a user's smart device where the software that controls the robot's actions and movements is provided.

The robot can carry and lift objects. This robot is a mobile robot. Motors will be used for the driving and mobile applications of the robots. One feature of the robot is that it can facilitate the collection of objects from the ground utilizing a mechanical solution. Actuators will be used for the lifting applications and accessories will be used for the collecting applications. This feature is a large benefit to the user in scenarios where an object has fallen, is dropped, or is too heavy for the user to move. This frees the user from having to depend on another person to place the object on the robot. The robot also has a mechanical lifting system, when activated this system lifts the collection plate. The collection plate is where objects or containers are placed on the robot. This system will use actuators and a mechanical system to perform the lifting. This lifting will be activated through software. This feature is vital to the robot because many individuals, who cannot carry items, also have mobility restrictions that extend to the physical action of lifting the items. One of the robot's most important features is its ability to integrate itself into the user's home environment. The robot utilizes mapping and visualization software to navigate around the home; it then stores its map so that it can more effectively transport items. This will be done through the use of a sensor package utilizing a number of different sensors. The use of multiple, distinct sensors reduces occurrences of error in the sensor readings. As well, the robot can be controlled manually.

The following detailed description refers to the preferred embodiment of the invention, but there is no intention of restricting the invention to the preferred embodiment. The description is provided to encourage those skilled in the art to make and use this invention. Other embodiments can include a different size collection plate, different size lifting mechanism, treads or different tires.

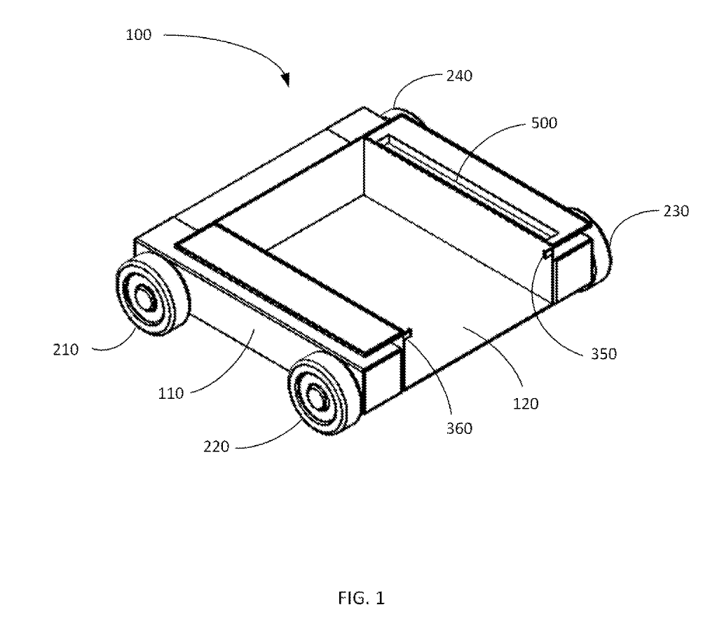

The autonomous robot 100 is displayed in FIG. 1. In this embodiment, the robot 100 is illustrated in its default position. The default position is the state where the robot has a collapsed lift mechanism 300, 310, empty collection plate 120, and no motors are engaged. The robot 100 has a base 110 which houses the enclosed compartment that contains the driving motors, lift motors, actuators, motor controllers, electronics, micro-processing units, sensors, and wheels 210, 220, 230, 240. The robot 100 also contains a collection plate 120, accessory housing 500, and latching mechanism 350, 360. In another embodiment the four wheels 210, 220, 230, 240 could be replaced by treads. The robot 100 has a width that permits it to navigate through standard household hallways. The robot's height changes depending on whether the lift motor is engaged.

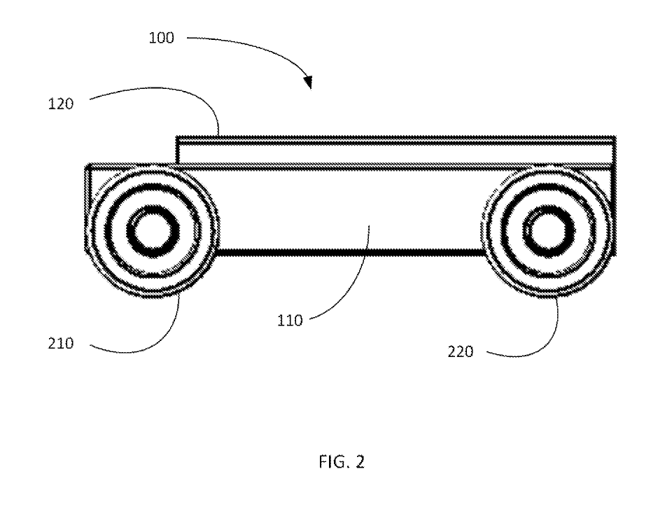

FIG. 2 showcases a side view of the robot 100 in its default position. Lowering the collection plate 120, results in a lower center of gravity. A lower center of gravity is more stable especially when the robot 100 is carrying objects.

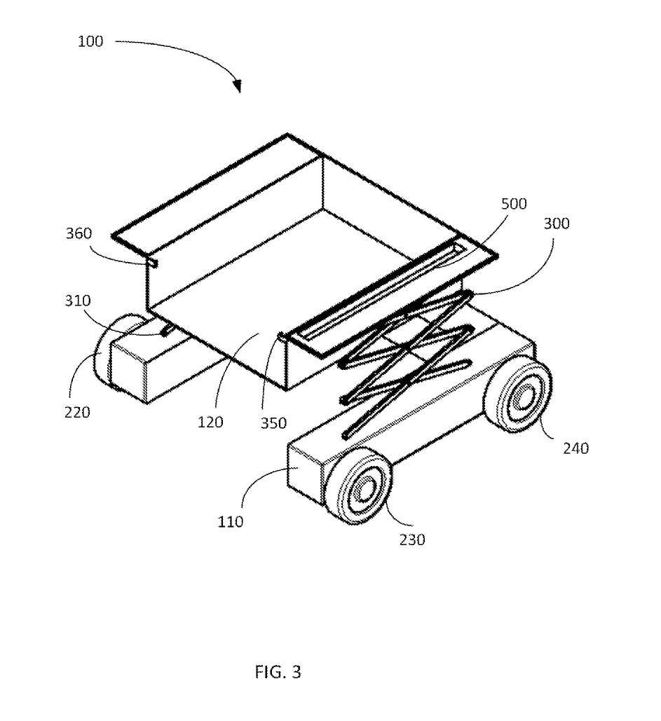

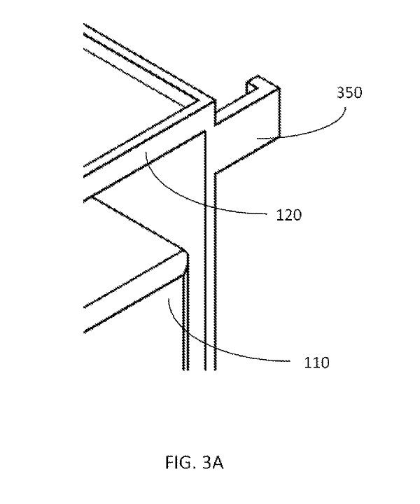

FIG. 3 showcases an angled view of the robot 100 with the lift mechanism 300, 310 engaged. In one embodiment the lift motor is attached to the lifting mechanism 300, 310 directly, while in another embodiment a mechanical drive is used and connected to the lift motor. This drive may include a ball screw, a worm drive, a linear actuator, or any other suitable mechanical drive which would create the needed power to lift the collection plate 120 and collection payload. The collection plate has a latching mechanism 350,360 to secure the collection plate 120 payload. This collection plate 120 payload may include a basket, bin, bag, or other suitable container which can hold small or loose items. The container must fit on the collection plate 120 and can be secured via the latching mechanism 350, 360. The latching mechanism 350, 360 may include hooks, a tethered cord, a bar, or any other device which would limit the movement and prevent the fall of the collection payload container. An example of this is illustrated in FIG. 3A.

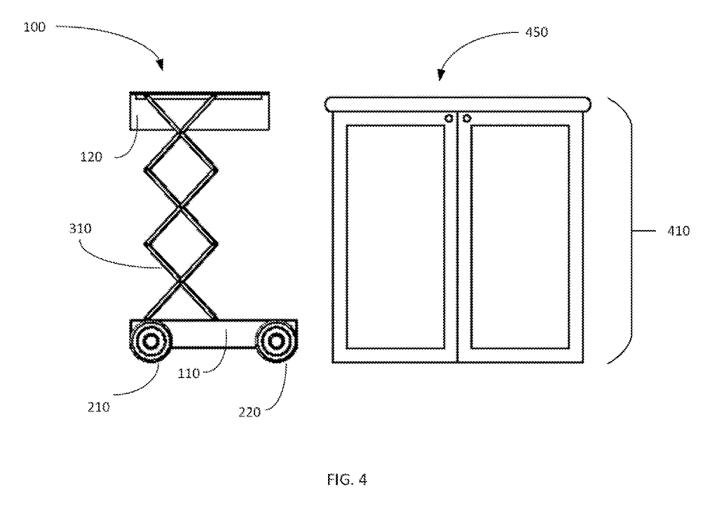

FIG. 4 depicts the robot 100 in a household setting. In this figure the robot 100 has approached the kitchen counter 450 and the collection plate 120 is raised to the height 410 equivalent to the kitchen counter 450. The robot 100 is capable of lifting its collection plate 120 to the height of a standard kitchen counter to aid the users that have mobility restrictions. These restrictions often prohibit the users from bending down to retrieve items including grocery bags and common kitchen utensils. The height 410 of the kitchen counter 450 is defined by standard building codes.

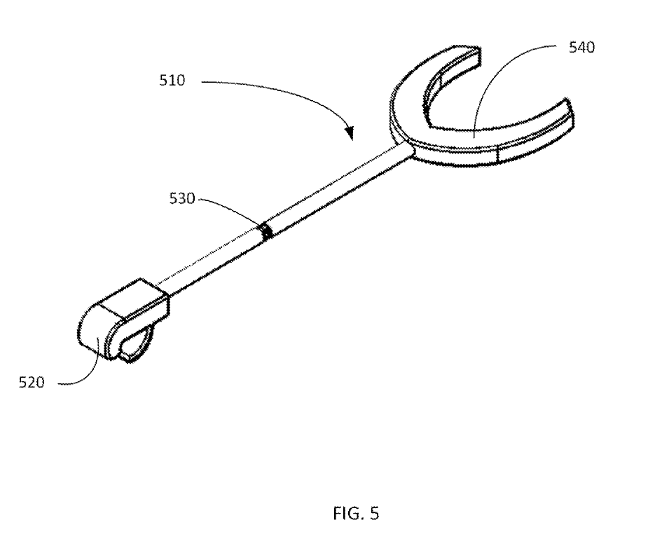

FIG. 5 depicts a gripper 510 which will be used as a collecting accessory. This is one example of a collecting apparatus which can be used with the robot 100. However, this does not limit the use of other collecting accessories such as different size grippers, scoopers, telescoping ramps, or any other suitable collecting accessory which will allow the user to customize the use of the robot 100 to their needs. Typical users of the robot 100 have mobility restrictions. These restrictions will often impede their ability to bend down and pick up fallen items, such as a towel or clothing from the floor. The robot 100 will house accessories, such as the gripper 510 to facilitate the ability to retrieve the fallen items. The collecting accessories will be housed in the collection accessory housing 500. In this embodiment, the gripper 510 can be folded at the hinge 530 for compact storage. The gripper 510 has an ergonomic handle 520 with soft rubber and trigger to close the gripper 510 end effector 540.

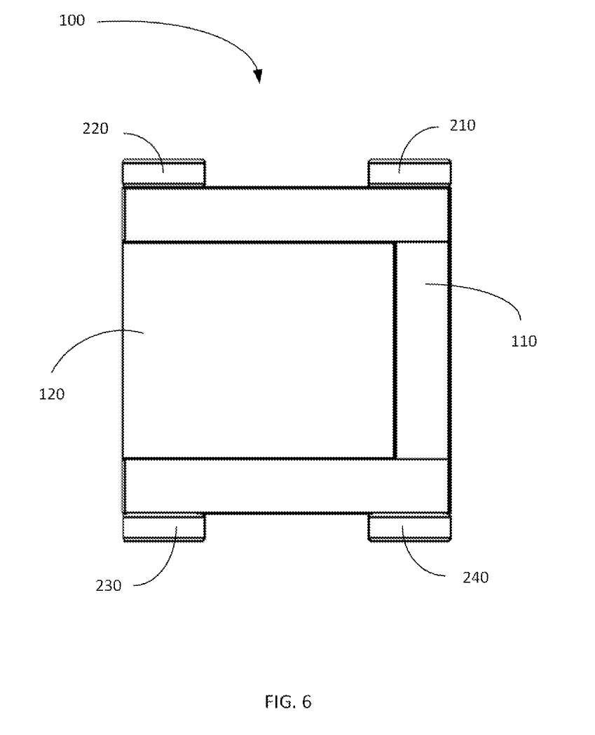

The base 110 is depicted in FIG. 6. The base 110 houses the batteries, drive motors, motor controllers, lift motor, micro-processing unit, communications transceivers, and sensor array. The sensor array includes a variety of sensors which help the robot navigate its surroundings. Examples of the sensors include a cliff sensor, a tilt sensor, imaging sensor, audio sensors, collision sensor, and range finders. The range sensors can be ultrasonic, infrared (IR), RADAR, and LIDAR based. In this embodiment, the base 110 houses the drive motors. In another embodiment, hub motors can be used; in such a case the base 110 may no longer house drive motors. In this embodiment, four wheels 210, 220, 230, 240 are mounted onto the base 110. The wheels 210, 220, 230, 240 shown consist of a non-slip, rubber material; however, the wheels 210, 220, 230, 240 can consist of a variety of materials including, but not limited to, different types of rubber, plastics, or any other suitable material. In another embodiment, two of the wheels can be omni-wheels which would allow the robot to move with more ease in lateral directions. Since the robot 100 is being targeted for an indoor environment, wheels will suffice, but users can also opt to use the robot 100 in an outdoor setting. In an embodiment for outdoor use, treads can be utilized since they are better suited for traversing an outdoor setting.

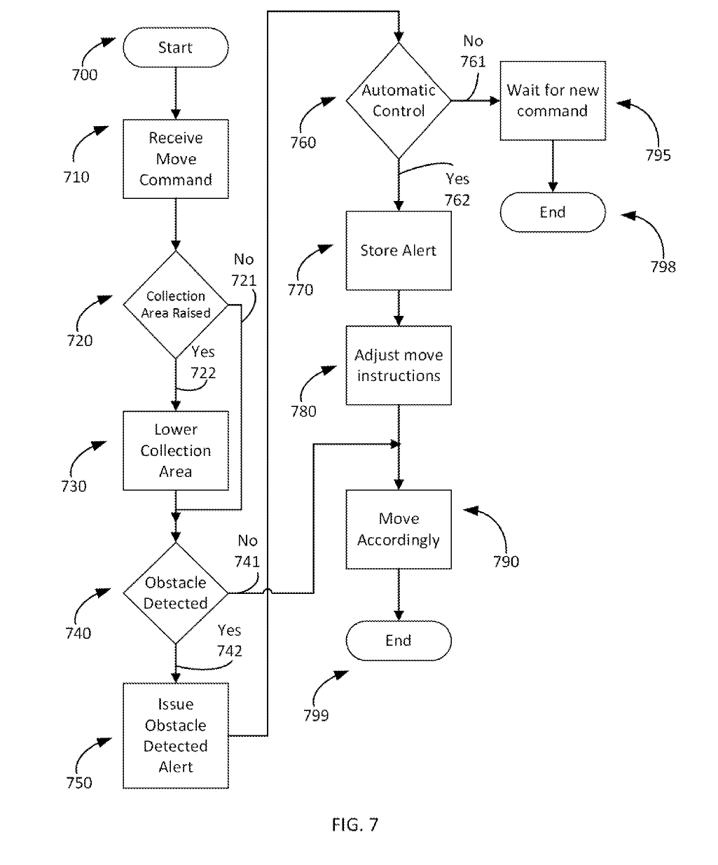

A software block diagram is shown in FIG. 7 to provide a high-level flowchart of the process that governs the movement of the robot 100. This high level process assumes that the robot 100 is not in hibernation and is accepting commands. The process 700 begins when the robot 100 receives a move command 710. Upon receiving a move command 710, the robot 100 will determine if the collection plate 120 is elevated 720. If the collection plate 120 is raised 722, a command 730 to lower the collection plate 120 is issued. If the collection plate 120 is already in the collapsed position 721, then it proceeds to check for obstacles. Having the collection plate 120 in a collapsed state reduces the center of gravity facilitating the robot's travel. The robot 100 will then check if the sensors detected an obstacle 740. If an obstacle has been detected 742, an alert is issued 750. If the sensors do not detect an issue 741, the robot 100 will proceed to move accordingly 790. The software will then check if the robot 100 is under automatic control 760. Automatic control refers to the robot 100 using a navigational map of its surroundings. If the robot 100 is under automatic control 762, the alert is stored 770 and flagged to indicate that the navigation map may need to be updated. If the robot 100 continuously encounters an obstacle, this means that the internal navigation map is not correct. If the robot 100 is not under automatic control 761, meaning it is in manual mode, it will await further instruction 795 and the process will terminate 798. In automatic mode the robot 100 will use its sensors to navigate its way avoiding the obstacle 780 and execute the received command 790 and terminate 799.

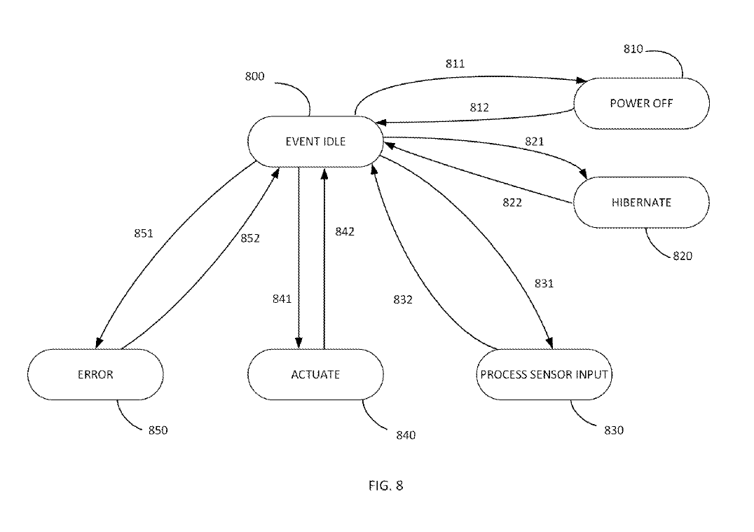

FIG. 8 depicts the finite state machine that models the software of the robot 100. When the robot 100 is POWERED ON 812, it enters the EVENT IDLE STATE 800. The robot 100 can be powered up via a physical switch located on the base 110. The robot's software is usually in the EVENT IDLE STATE 800 and changes to a different state depending on events. These events can be an actuator command 841, sensor input 831, error condition 851, hibernate command 821, or off command 811. If the software receives an actuator command 841, it will enter the ACTUATE STATE 840, and will issue a command acknowledgement 842. Examples of the actuator commands can include lift, lower, forward, reverse, left, right, stop, and release. If the software receives a sensor input 831, the software enters the PROCESS SENSOR INPUT STATE 830 and will issue a sensor acknowledgement 832. The sensor acknowledgement 832 may embed an actuator command 841. For instance, a range sensor may detect an object in the path of the robot 100. The sensor acknowledgement 832 of the PROCESS SENSOR INPUT STATE 830 will embed an actuator command 841 to move the robot 100 out of the path of the object. If the robot 100 encounters an error condition 851, it will enter the ERROR STATE 850 and an error acknowledgement is issued 852. An example of an error condition could be the loss of connectivity to the smart device or the battery level is below a pre-defined threshold. The error acknowledgement 852 will contain information on the type of error. Another trigger event would be a POWER OFF command 811 and the robot 100 will acknowledge a shutdown command 812 and then proceed to power itself down and enter the OFF STATE 810. In one embodiment, the robot 100 also has a HIBERNATE STATE 820. The HIBERNATE STATE is a low-power state where a limited about of sensor and actuators are receiving power. When the robot 100 receives a hibernate command 821, the robot 100 will acknowledge with a hibernate acknowledgement 822 and proceed to go into the HIBERNATE STATE 820. In another embodiment, the hibernate acknowledgement 822 can also embed an actuate command 841 for the robot 100 to go to a prescribed location, including but not limited to the charging station. After reaching the prescribed location will then enter the HIBERNATE STATE 820. Although the robot 100 may be in the HIBERNATE STATE 820, the robot 100 can enter the EVENT IDLE STATE 800 with certain pre-defined sensor input.

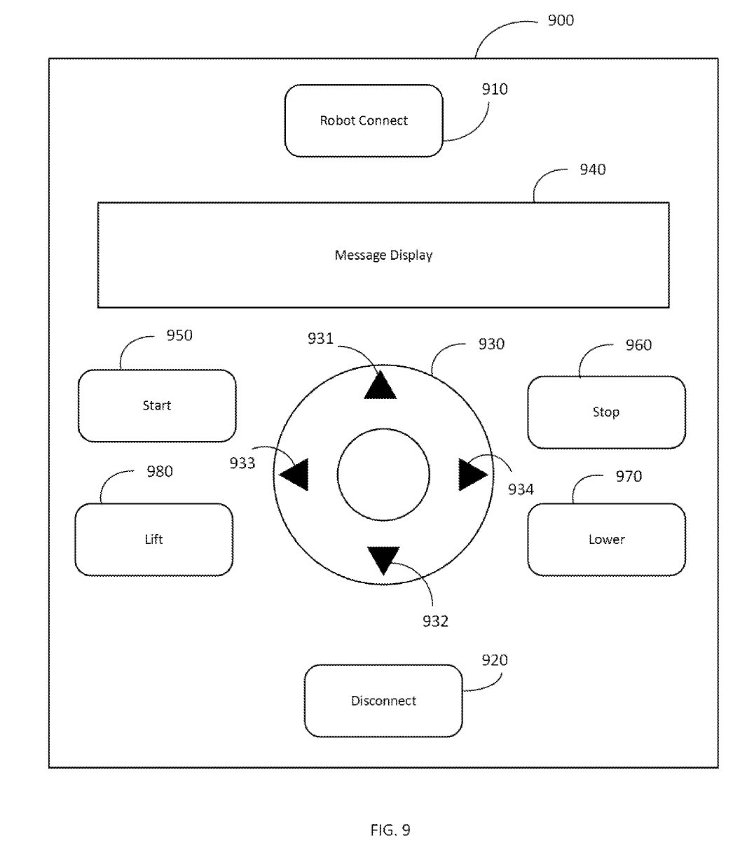

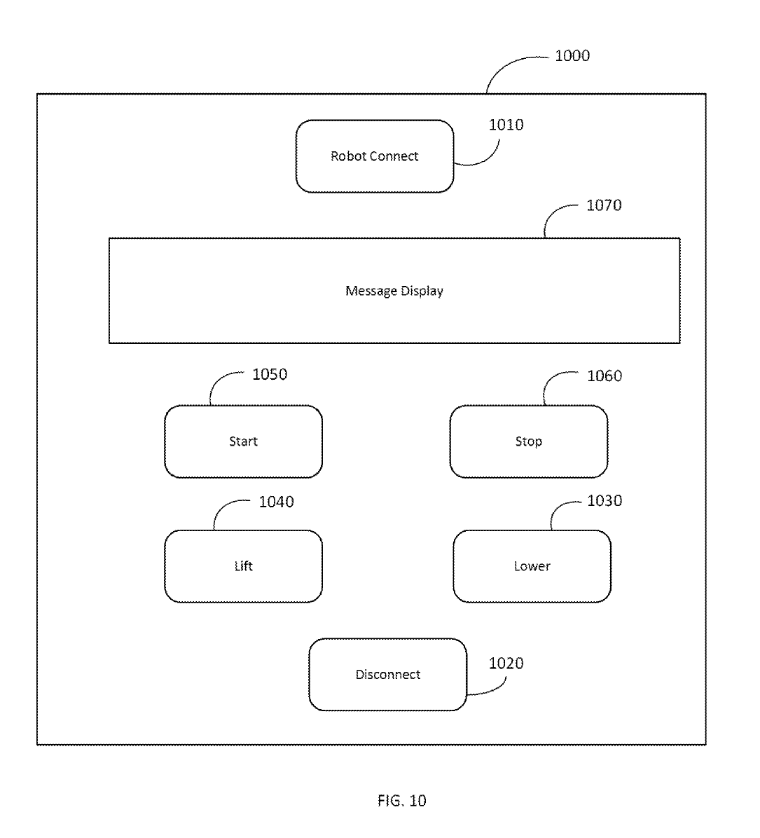

The robot 100 may be controlled manually through the use of a smart device. Smart devices may include, but are not limited to, smart phones or tablets. If the robot 100 is being controlled manually through the use of the smart device, software will be provided for the smart device. FIG. 9 depicts the software screen of the smart device's application 900. In this embodiment, the application controls the movement of the robot 100 via software button controls. FIG. 10 showcases the smart device's application screen 1000. In this embodiment, the smart device's own sensors are used to guide the robot's movements. For instance, the gyroscope on a smart phone can be used to sense when the phone is titled to the left. When the software application receives this sensor input, the robot 100 will then move to the left.

FIG. 9 denotes that one software embodiment will rely on software control buttons to manipulate and communicate with the robot 100. The Connect control button 910 is pressed when the user needs to set up wireless communications to the robot 100. Examples of the wireless communication protocols that are supported are WiFi, Bluetooth, ZigBee, radio frequency and light based protocols. The Disconnect button 920 is utilized when the user wishes to terminate the wireless communications with the robot 100. Movement of the robot 100 is accomplished via a virtual joystick button controller 930. When the user wishes for the robot 100 to move forward, the user will press the top arrow 931 on the virtual joystick button controller 930. If the user wishes the robot 100 to move in reverse, the user must press the bottom arrow 932 on the virtual joystick button controller 930. For the robot 100 to move in the leftward direction, the user must press the left arrow 933. The right arrow 934 on the virtual joystick button controller 930 will command the robot 100 to move in the rightward direction. This software embodiment also provides two buttons to control when the collection plate 120 should be lowered or lifted. When the Lift control button 980 is pressed, the collection plate 120 will raise to the prescribed height. Pressing the Lower control button 970, results in the collection plate 120 being lowered to its collapsed height. In this embodiment, the software application also provides a Message Display 940. This Message Display 940 will showcase alert messages as well status messages. An example of an alert would be the encounter of an obstacle. A status message can be a message indicating that the communications between the robot 100 and the smart device have been disconnected. The overall control of the robot 100 is governed by the Start control button 950 and Stop control button 960. When pressed, the Start control button 950 will bring the robot 100 out of its HIBERNATE STATE 820 and will be in the EVENT IDLE STATE 800 waiting for movement or manipulation commands. Pressing the Stop control button 960 will force the robot 100 to stop the drive motors and lower its collection plate 120. The robot 100 will be put in the EVENT IDLE STATE 800.

Another software embodiment of the manual control is depicted in FIG. 10. In this embodiment, the user relies on the smart device's own sensors to guide the movement of the robot 100. However, control of the lifting and lowering of the collection plate 120 as well as the control of the communications with the robot 100 will still use software control buttons. Communications between the robot 100 and the smart device is wireless. WiFi, Bluetooth, ZigBee, radio frequency and light based protocols are examples of the wireless communications that can be supported. To communicate with the robot 100 the user must press the Connect control button 1010. This engages wireless connection between the robot 100 and the smart device. To break-off the connection, the user will press the Disconnect control button 1020. The manipulation of the lowering and the raising of the collection plate 120 is controlled by the Lower control button 1030 and the Lift control button 1040. Pressing the Lower control button 1030 on the smart device's application screen 1000 will result in the lift motor being engaged and lowering the collection plate 120. When the user presses the Lift control button 1040, the lift motor is engaged and results in the collection plate 120 being raised to a prescribed height. The software also provides a Message Display 1070. The Message Display 1070 can be used for the display of status messages or alerts. An example of a status message is that the robot 100 is disconnected, while an alert can indicate that an obstacle has been detected. The Start control button 1050 and Stop control button 1060 are responsible for the overall control of the robot 100. When the Start control button 1050 is pressed, the robot 100 is awaken out of the HIBERNATE STATE 820, enters the EVENT IDLE STATE 800, and waits for instruction regarding manipulation or movement. When the Stop control button 1060 is pressed, the robot 100 will stop its drive motors, lower its collection plate 120, and enter the HIBERNATE STATE 820. In this embodiment, the movement of the robot 100 is governed by the smart device's own sensors. For instance, when the user tilts the device, the smart phone's gyroscope will detect the tilt. The software will translate the gyroscope sensor data and command the robot 100 to move in the direction of the tilt. If the user tilts the smart phone to the left, the robot 100 will move to the left. Likewise, a tilt to right by the smart phone will result in the robot 100 moving to the right. Titling the smart device forward will correspond in the robot 100 moving forward. The robot 100 will move in reverse in response to the smart device being tilted backward.

The forgoing description is exemplary embodiments of the invention so a person skilled in the art would be capable of recognizing from the figures, claims, and descriptions that changes could be made to the preferred embodiments without departing from the scope of the invention as defined by the following claims.

What is claimed:

1. A mobile robot comprising:
a driving mechanism disposed within its base to move the robot forward, reverse, left, right, or a combination of these directions;
a collection plate to hold objects;
a housing for assistive accessories;
a lift mechanism that raises the collection plate;
electronic sensors to navigate its surroundings;
electronic communications transceivers;
micro-processing system;
a user interface.

2. The robot of claim 1, wherein contains a collection plate for carrying items. This collection plate is accessible from the top of the robot. The robot will be able to carry objects up to 50 lbs or 23 Kg.

3. The robot of claim 1, wherein contains a lift mechanism that can elevate the collection plate to heights up to 4 feet or about 1.2 meters.

4. The robot of claim 1, wherein contains housing for assistive accessories which are used as collecting mechanisms to place objects on the collection plate.

5. The robot of claim 1, wherein contains a latching mechanism so that when a container is placed on the collection plate it can be secured while the robot is stationary or in motion.

6. The robot of claim 1, wherein the base has electronics for navigation of its surroundings, obstacle avoidance, and user interaction.

7. The robot of claim 6, wherein its sensors include collision sensors, tilt sensors, imaging sensors, and range finders for navigation and obstacle avoidance.

8. The robot of claim 6, wherein its communications include transceivers to triangulate electronic signals.

9. The robot of claim 6, wherein its electronics include audio sensors and actuators.

10. The robot of claim 6, wherein its electronics rely on software to perform the ability to transcribe voice commands to electrical signals for robotic control and navigation.

11. The robot of claim 6, wherein its electronics rely on software to create navigational maps and use such maps to navigate its surroundings.

12. The robot of claim 1, wherein it has a user interface to provide electronic and verbal control of robot.

13. The robot of claim 12, wherein it has a user interface that can be a smart device containing software that can be used for driving and commanding the robot to lift or lower its collection plate.

14. The robot of claim 12, wherein it has a user interface for the user to audibly command the robot's drive and lift mechanisms.

15. The robot of claim 12, wherein it has a user interface for storing navigational maps of the surrounding areas and training the robot to navigate said maps.

16. The robot of claim 12, wherein it has a user interface for training the robot's audio electronics to discern verbal commands from different users.

17. The robot of claim 1, wherein it has a micro-processing system to translate robot commands whether they are verbal from a user or via a smart device.

18. The robot of claim 17, wherein it has a micro-processing system that can process sensor inputs and actuate motors accordingly.

19. The robot of claim 17, wherein it has a micro-processing system for building and storing navigational maps of the surrounding areas.
